(19) United States
(12) Patent Application Publication
(10) Pub. No.: US 2026/0124842 A1
(43) Pub. Date: May 7, 2026

(54) MEDIUM TRANSPORT DEVICE, RECORDING DEVICE, RECORDING SYSTEM, AND CONTROL METHOD FOR MEDIUM TRANSPORT DEVICE

(71) Applicant: SEIKO EPSON CORPORATION, TOKYO (JP)

(72) Inventors: Hiroyuki MAEDA, MATSUMOTO-SHI (JP); Riku MAEDA, SHIOJIRI-SHI (JP); Chiaki SHIMADA, AZUMINO-SHI (JP)

(21) Appl. No.: 19/380,111

(22) Filed: Nov. 5, 2025

(30) Foreign Application Priority Data
Nov. 5, 2024 (JP) 2024-193403
Apr. 4, 2025 (JP) 2025-062495

(51) Int. Cl. B41J 13/00; B41J 13/03; B41J 13/26

(52) U.S. Cl. CPC B41J 13/0018; B41J 13/03; B41J 13/26

(57) ABSTRACT

A medium transport device includes a transport section configured to transport a medium and a control section that controls the transport section; wherein the transport section includes a first transport section that transports the medium and a second transport section that transports the medium downstream of the first transport section. The control section selects a transport speed of the medium by the second transport section from a plurality of types of predetermined corrected transport speeds based on a difference between an arrival time of the medium to a predetermined position downstream of the first transport section and a reference arrival time. The control section calculates a corrected transport time for transporting the medium at the corrected transport speed based on the difference and the selected corrected transport speed.

The present application is based on, and claims priority from JP Application Serial Number 2024-193403, filed Nov. 5, 2024, and JP Application Serial Number 2025-062495, filed Apr. 4, 2025, the disclosures of which are hereby incorporated by reference herein in its entirety.

### BACKGROUND

### 1. Technical Field

The present disclosure relates to a medium transport device, a recording device, a recording system, and a control method for a medium transport device.

### 2. Related Art

For example, as in JP-A-2021-187588, a medium transport device is disclosed that changes a transport speed for transporting a subsequent sheet of medium on the basis of a difference between the arrival time at which a preceding sheet of medium arrived at a predetermined position and a reference arrival time. This makes it possible to improve throughput for the subsequent sheet of medium.

However, in such a medium transport device, when the transport speed is corrected, the calculation of the corrected transport speed becomes complicated. Therefore, there is a concern that the medium cannot be smoothly transported. Accordingly, it is desired to improve the medium transport performance.

### SUMMARY

A medium transport device that overcomes the above-described problem includes a transport section configured to transport a medium and a control section configured to control the transport section, wherein the transport section includes a first transport section configured to transport a medium and a second transport section configured to transport a medium downstream of the first transport section and the control section selects a transport speed of the medium by the second transport section from a plurality of types of predetermined corrected transport speeds based on a difference between an arrival time of the medium at a predetermined position downstream of the first transport section and a reference arrival time and calculates a corrected transport time for transporting the medium at the corrected transport speed based on the difference and the selected corrected transport speed.

A recording device that overcomes the above-described problem includes a transport section configured to transport a medium and a recording section that performs recording on the medium transported by the transport section; and a control section that controls the transport section and the recording section, wherein the transport section includes a first transport section configured to transport a medium and a second transport section configured to transport a medium downstream of the first transport section and the control section selects a transport speed of the medium by the second transport section from a plurality of types of predetermined corrected transport speeds based on a difference between an arrival time of the medium at a predetermined position downstream of the first transport section and a reference arrival time and calculates a corrected transport time for transporting the medium at the corrected transport speed based on the difference and the selected corrected transport speed.

A recording system that overcomes the above-described problem includes a transport section configured to transport a medium and a recording section configured to record on the medium transported by the transport section; a post-processing section configured to perform post-processing on the medium that was recording on by the recording section; and a control section configured to control the transport section, the recording section, and the post-processing section, wherein the transport section includes a first transport section configured to transport a medium, and a second transport section configured to a medium downstream of the first transport section and the control section selects a transport speed of the medium by the second transport section from a plurality of types of predetermined corrected transport speeds based on a difference between an arrival time of the medium at a predetermined position downstream of the first transport section and a reference arrival time and calculates a corrected transport time for transporting the medium at the corrected transport speed based on the difference and the selected corrected transport speed.

A control method for a medium transport device that overcomes the above-described problem is for a medium transport device including a first transport section that transports a medium and a second transport section that transports a medium downstream of the first transport section, the control method for the medium transport device including selecting a transport speed of the medium by the second transport section from a plurality of types of predetermined corrected transport speeds based on a difference between an arrival time of the medium at a predetermined position downstream of the first transport section and a reference arrival time and calculating a corrected transport time for transporting the medium at the corrected transport speed based on the difference and the selected corrected transport speed.

### BRIEF DESCRIPTION OF THE DRAWINGS

FIG. 1 is a schematic diagram illustrating a recording device according to a first embodiment.

FIG. 2 is a schematic diagram illustrating control contents of a second drive section according to the first embodiment.

FIG. 3 is a schematic diagram illustrating control contents of a second drive section according to the first embodiment.

FIG. 4 is a schematic diagram illustrating control contents of a second drive section according to the first embodiment.

FIG. 5 is a schematic diagram illustrating control contents of a second drive section according to the first embodiment.

FIG. 6 is a schematic diagram illustrating a relationship between a difference between the arrival time and the reference arrival time and the corrected transport speed in the first embodiment.

FIG. 7 is a flowchart illustrating the transport data control process according to the first embodiment.

FIG. 8 is a schematic diagram illustrating a recording system of a second embodiment.

FIG. 9 is a schematic diagram illustrating a recording device according to a third embodiment.

FIG. 10 is a schematic diagram illustrating control contents of a second drive section according to the third embodiment.

FIG. 11 is a schematic diagram showing control contents of a second drive section according to the third embodiment.

### DESCRIPTION OF EMBODIMENTS

### First Embodiment

Hereinafter, an embodiment of a recording device including a medium transport device and a control method for the medium transport device will be described with reference to the drawings. Hereinafter, the description will be made assuming that the recording device is placed on a horizontal plane.

### Configuration of Recording Device 11

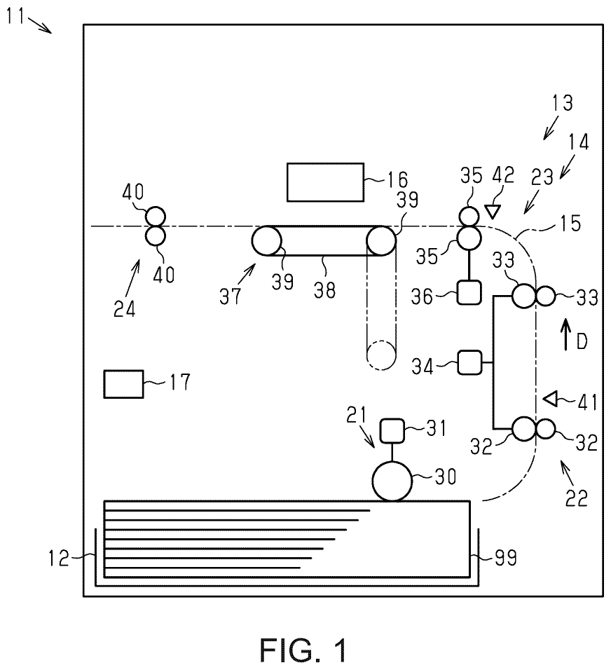

As shown in FIG. 1, the recording device 11 is configured to record an image on a medium 99. The recording device 11 may be, for example, an ink jet printer that records an image by ejecting ink, which is an example of a liquid, onto the medium 99.

The recording device 11 may include a medium accommodation section 12. The recording device 11 may include a plurality of medium accommodation sections 12. The medium accommodation section 12 can storage the medium 99. The medium accommodation section 12 can storage plural sheets of medium 99 in a stacked state. The medium accommodation section 12 may be a tray on which one or more sheets of medium 99 can be stacked.

The recording device 11 includes a medium transport device 13. The medium transport device 13 is configured to transport a medium 99 for recording an image. The medium transport device 13 includes the transport section 14. The transport section 14 is configured to transport the medium 99. The transport section 14 transports the medium 99 in a transport direction D along a transport path 15. The transport path 15 is a path on which the medium 99 is transported. The transport direction D is a direction in which the medium 99 is transported. In the drawing, the transport path 15 is indicated by single dot chain line. In the present embodiment, upstream is upstream in the transport direction D, and downstream is downstream in the transport direction D.

The recording device 11 includes a recording section 16. The recording section 16 is configured to record an image on the medium 99. The recording section 16 is configured to perform recording on the medium 99 transported by the transport section 14. The recording section 16 may perform recording on the medium 99 by ejecting liquid onto the medium 99. The recording section 16 is provided at a position along the transport path 15.

The recording section 16 is a line head type, but may be a serial head type. A line head type is a type that, by the head extending in an intersecting direction that intersects the transport direction D, can eject liquid at once across the medium 99 in the intersecting direction. A serial head is a type in which the head can eject liquid onto the medium 99 while moving in the intersecting direction.

The recording device 11 includes a control section 17. The control section 17 comprehensively controls the recording device 11. The control section 17 controls various operations performed by the recording device 11. The control section 17 controls the transport section 14 and the recording section 16.

The control section 17 may be configured as a circuit including α: one or more processors that execute various processes according to a computer program, β: one or more dedicated hardware circuits that execute at least a part of various processes, or γ: a combination of these. The hardware circuit is, for example, an application-specific integrated circuit. The processor includes a CPU and a memory, such as a RAM and a ROM, and the memory stores program code or instructions configured to cause the CPU to execute processes. Memory or computer readable medium includes any readable medium that can be accessed by a general-purpose or dedicated computer.

The medium transport device 13 may include a control section 17. The control section 17 may integrally control the medium transport device 13 instead of the recording device 11. The control section 17 may control various operations executed by the medium transport device 13.

The transport section 14 includes a first transport section 21 and a second transport section 22. That is, the recording device 11 and the medium transport device 13 include the first transport section 21 and the second transport section 22. The transport section 14 may include a third transport section 23 and a discharge transport section 24. That is, the recording device 11 and the medium transport device 13 may include the third transport section 23 and the discharge transport section 24.

The first transport section 21, the second transport section 22, the third transport section 23, and the discharge transport section 24 are provided at positions along the transport path 15. The first transport section 21, the second transport section 22, the third transport section 23, and the discharge transport section 24 are disposed in this order from upstream to downstream along the transport path 15.

The first transport section 21 is disposed upstream of the recording section 16. The second transport section 22 is disposed upstream of the recording section 16. The third transport section 23 is disposed between a position upstream of the recording section 16 and a position facing the recording section 16. That is, the recording section 16 performs recording on the medium 99 transported by the third transport section 23. The discharge transport section 24 is disposed downstream of the recording section 16.

The first transport section 21 is located on the most upstream of the transport path 15. The first transport section 21 is configured to transport the medium 99. The first transport section 21 is configured to transport the uppermost sheet of medium 99 among the sheets of the medium 99 accommodated in the medium accommodation section 12. The first transport section 21 is a feeding section that feeds the medium 99 accommodated in the medium accommodation section 12. The first transport section 21 is configured to transport the medium 99 from the medium accommodation section 12 to the second transport section 22.

The first transport section 21 includes a feed roller 30 and a first transport drive section 31. The feed roller 30 feeds the medium 99 by rotating. The feed roller 30 is located so as to come into contact with the uppermost sheet of medium 99 loaded in the medium accommodation section 12. The feed roller 30 feeds the medium 99 one sheet at a time from the medium accommodation section 12.

The first transport drive section 31 is connected to the feed roller 30. The first transport drive section 31 is a drive source that rotates the feed roller 30. The first transport drive section 31 may be a motor. The first transport drive section 31 is driven based on a drive signal from the control section 17, thereby rotating the feed roller 30.

The second transport section 22 is located downstream of the first transport section 21. The second transport section 22 is configured to transport the medium 99. The second transport section 22 is configured to transport the medium 99 from the first transport section 21 to the third transport section 23.

The second transport section 22 includes a first roller pair 32, a second roller pair 33, and a second transport drive section 34. The second roller pair 33 is located downstream of the first roller pair 32. The first roller pair 32 and the second roller pair 33 transport the medium 99 by rotating.

The second transport drive section 34 is connected to the first roller pair 32. The second transport drive section 34 is connected to the second roller pair 33. The second transport drive section 34 is a drive source that rotates the first roller pair 32 and the second roller pair 33. The second transport drive section 34 may be a motor. The second transport drive section 34 is driven based on a drive signal from the control section 17 to rotate the first roller pair 32 and the second roller pair 33.

The third transport section 23 is located downstream of the second transport section 22. The third transport section 23 is configured to transport the medium 99. The third transport section 23 is configured to transport the medium 99 from the second transport section 22 to the discharge transport section 24.

The third transport section 23 includes a registration roller pair 35 and a third transport drive section 36. That is, the recording device 11 and the medium transport device 13 include the registration roller pair 35 and the third transport drive section 36.

The registration roller pair 35 is provided downstream of the second transport section 22. The medium 99 transported by the second transport section 22 butts against the registration roller pair 35. The registration roller pair 35 is configured to correct skew of the medium 99. The registration roller pair 35 transports the medium 99 by rotating.

The third transport drive section 36 is connected to the registration roller pair 35. The third transport drive section 36 is a drive source that rotates the registration roller pair 35. The third transport drive section 36 may be a motor. The third transport drive section 36 is driven based on a drive signal from the control section 17 to rotate the registration roller pair 35.

The third transport section 23 includes a medium support section 37. The medium support section 37 is provided at a position along the transport path 15. The medium support section 37 is configured to transport the medium 99 in a state of supporting the medium 99. The medium support section 37 is provided at a position facing a recording section 16 with the transport path 15 interposed therebetween.

The medium support section 37 may include an endless transport belt 38 and a pair of pulleys 39. The transport belt 38 is stretched between a pair of pulleys 39. The transport belt 38 faces the recording section 16 with the transport path 15 interposed therebetween. The transport belt 38 supports a part of the medium 99 in a flat state. The transport belt 38 transports the medium 99 along the transport path 15 by rotating in a state of clinging to the medium 99. One pulley 39 is rotated by a drive force from a belt driving section (not shown). Accordingly, the transport belt 38 transports the medium 99 along the transport path 15.

The medium support section 37 is rotatable about one pulley 39. The medium support section 37 is provided so as to be movable between a support position indicated by solid line and a retracted position indicated by two dot chain line by rotating about one pulley 39. The support position is a position at which the medium 99 is supported and caused to face the recording section 16. The retracted position is a position away from the recording section 16. The medium support section 37 moves to the retreat position, and by this, maintenance of the recording section 16 is performed by a maintenance device (not shown).

The discharge transport section 24 is located downstream of the third transport section 23. The discharge transport section 24 is configured to transport the medium 99. The discharge transport section 24 is configured to transport the medium 99 from the third transport section 23 to the outside of the recording device 11.

The discharge transport section 24 includes a discharge roller pair 40. The discharge roller pair 40 transports the medium 99 by rotating. The discharge roller pair 40 is rotated by a drive force from a discharge driving section (not shown). The discharge drive section may be a motor.

The medium transport device 13 includes a first medium detection section 41 and a second medium detection section 42. That is, the recording device 11 includes the first medium detection section 41 and the second medium detection section 42. The first medium detection section 41 and the second medium detection section 42 may be physical sensors or optical sensors.

The first medium detection section 41 is provided at a position along the transport path 15. The first medium detection section 41 is provided downstream of the first transport section 21. The first medium detection section 41 is provided downstream of the first roller pair 32. The first medium detection section 41 is provided upstream of the second roller pair 33. That is, the first medium detection section 41 is provided between the first roller pair 32 and the second roller pair 33 along the transport path 15.

The first medium detection section 41 is configured to detect the medium 99 transported along the transport path 15. In particular, the first medium detection section 41 is configured to detect the leading end of the medium 99. That is, the first medium detection section 41 detects that the medium 99 is being transported by the second transport section 22. Hereinafter, a position at which the first medium detection section 41 can detect the medium 99 is referred to as a predetermined position. The predetermined position can be said to be a position downstream of the first transport section 21. The timing at which the first medium detection section 41 detects the leading end of the medium 99 is referred to as a first detection timing.

The second medium detection section 42 is provided at a position along the transport path 15. The second medium detection section 42 is provided downstream of the second transport section 22. The second medium detection section 42 is provided upstream of the registration roller pair 35. The second medium detection section 42 may be provided upstream of the registration roller pair 35 by a slight distance.

The second medium detection section 42 is configured to detect the medium 99 transported along the transport path 15. In particular, the second medium detection section 42 is configured to detect the leading end of the medium 99. The second medium detection section 42 may be configured to detect the leading end of the medium 99 that abuts against the registration roller pair 35. Hereinafter, a position at which the second medium detection section 42 can detect the medium 99 is referred to as a detection position. The timing at which the second medium detection section 42 detects the leading end of the medium 99 is referred to as a second detection timing.

### Control Content of Second Transport Section 22

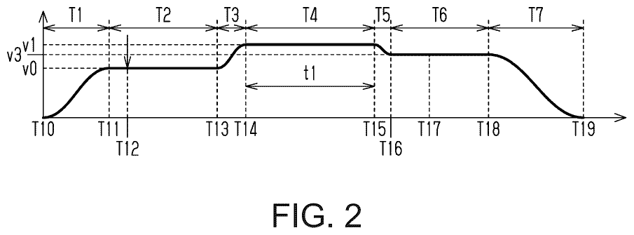

Here, the control content of the second transport section 22 will be described with reference to FIGS. 2 to 6.

As illustrated in FIG. 2, the transport speed of the second transport section 22 is controlled for each medium 99 transported along the transport path 15. The transport speed of the second transport section 22 is controlled for each control period for transporting the medium 99.

The control period includes a first acceleration period T1, a normal transport period T2, a second acceleration period T3, a corrected transport period T4, a first deceleration period T5, a butting transport period T6, and a second deceleration period. T7

The first acceleration period T1 is a period in which the transport speed of the second transport section 22 is accelerated from 0 to the normal transport speed v0. The normal transport period T2 is a period in which the medium 99 is transported at the normal transport speed v0.

The normal transport speed v0 is a transport speed at which the medium 99 is received from the first transport section 21. The normal transport speed v0 is a speed equal to or higher than the transport speed at which the medium 99 is transported by the first transport section 21. The normal transport speed v0 is equal to the transport speed at which the medium 99 is transported by the third transport section 23. In particular, the normal transport speed v0 is equal to the transport speed at which the medium 99 is transported by the medium support section 37. That is, the normal transport speed v0 is equal to the transport speed when recording is performed on the medium 99. In this manner, the normal transport speed v0 can be said to be a standard transport speed in the recording device 11 and the medium transport device 13.

The second acceleration period T3 is a period in which the transport speed of the second transport section 22 is accelerated to a corrected transport speed. The corrected transport period T4 is a period in which the medium 99 is transported at the corrected transport speed. In FIG. 2, the corrected transport speed is a reference speed v1.

The corrected transport speed is higher than the normal transport speed v0. This makes it possible to improve the transport speed of the second transport section 22. In this way, it is possible to improve the throughput of transporting the medium 99.

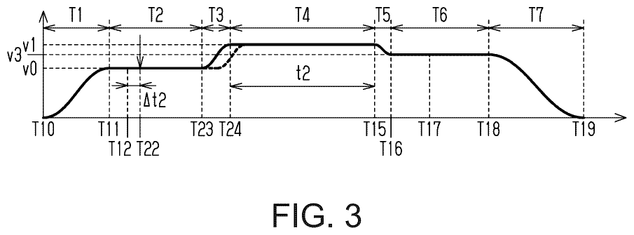

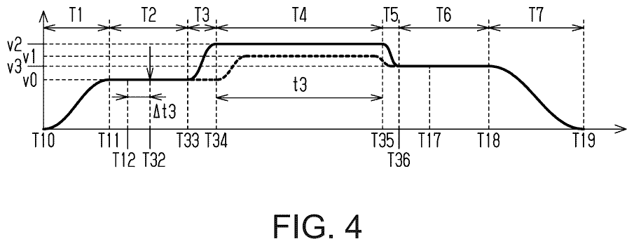

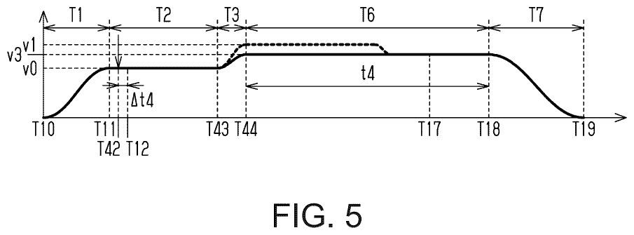

The corrected transport speed includes a plurality of speeds. Any one of a plurality of speeds is selected as the corrected transport speed. The corrected transport speed includes the reference speed v1 shown in FIGS. 2 and 3, a high speed v2 shown in FIG. 4, and a low speed v3 shown in FIG. 5. The reference speed v1 is a speed serving as a reference of the corrected transport speed. The reference speed v1 is a speed based on a reference arrival time (to be described later). The high speed v2 is higher than the reference speed v1. The low speed v3 is lower than the reference speed v1. The low speed v3 is equal to a butting transport speed v3 (to be described later).

As described above, the reference speed v1, the high speed v2, and the low speed v3 are higher than the normal transport speed v0. That is, the reference speed v1, the high speed v2, and the low speed v3 are higher than the transport speed of the first transport section 21. In other words, the normal transport speed v0 is slower than the corrected transport speed. The normal transport speed v0 is lower than the low speed v3 and the butting transport speed v3.

The first deceleration period T5 is a period in which the transport speed of the second transport section 22 is decelerated from the corrected transport speed to the butting transport speed v3. The butting transport period T6 is a period in which the medium 99 is transported at the butting transport speed v3. The second deceleration period T7 is a period in which the transport speed of the second transport section 22 is decelerated from the butting transport speed v3 to 0.

The butting transport speed v3 is a transport speed at which the second transport section 22 butts the medium 99 against the registration roller pair 35. The butting transport speed v3 is lower than the reference speed v1 and the high speed v2. The butting transport speed v3 is equal to the low speed v3.

The second deceleration period T7 includes a timing at which the registration roller pair 35 starts re-transporting the medium 99 that have been brought into contact with the registration roller pair 35. The registration roller pair 35 transports the medium 99 at the normal transport speed v0.

In a state where the rotation of the registration roller pair 35 is stopped, the second transport section 22 causes the medium 99 to butt against the registration roller pair 35 at the butting transport speed v3, and by this, the medium 99 is bent. In the second deceleration period T7, the transport speed of the second transport section 22 is decelerated from the butting transport speed v3 to 0, and thus deflection occurring in the medium 99 is eliminated. Although the timing after the timing of the reference numeral T19 is not shown in FIGS. 2 to 5, the transport speed by the second transport section 22 is accelerated from 0 to the normal transport speed v0 before the deflection generated in the medium 99 is completely eliminated. By accelerating the transport speed of the second transport section 22 from 0 to the normal transport speed v0 before the deflection generated in the medium 99 is completely eliminated, it is possible to suppress the second transport section 22 from becoming a transport load. In a case where plural sheets of the medium 99 are consecutively transported, a period in which the transport speed of the second transport section 22 is accelerated from 0 to the normal transport speed v0 before deflection occurring in the medium 99 is completely eliminated corresponds to the first acceleration period T1 for the subsequent sheet of medium 99.

As shown in FIGS. 2 to 5, the corrected transport speed and the corrected transport time are controlled based on the arrival time when the medium 99 arrives at the predetermined position as detected by the first medium detection section 41. The arrival time is a time from when the transport of the medium 99 is started until the medium 99 arrives at a predetermined position. That is, the arrival time is a time from when the first transport section 21 starts transporting the medium 99 until the medium 99 arrives at a predetermined position. The corrected transport time is a time for transporting the medium 99 at the corrected transport speed.

The memory stores a reference arrival time in advance. The reference arrival time is a time serving as a reference of the arrival time. The reference arrival time is set to the normal transport period T2. Specifically, the reference arrival time is the timing of the reference numeral T12 shown in FIGS. 2 to 5.

The corrected transport speed and the corrected transport time are controlled based on the difference between the arrival time and the reference arrival time. Specifically, the differences between the arrival time and the reference arrival time are a second difference Δt2 shown in FIG. 3, a third difference Δt3 shown in FIG. 4, and a fourth difference Δt4 shown in FIG. 5. In FIG. 2, the difference between the arrival time and the reference arrival time is 0. Hereinafter, the difference between the arrival time and the reference arrival time is simply referred to as a difference.

The difference is a numerical value obtained by subtracting the reference arrival time from the arrival time. The difference is a positive numerical value when the arrival time is longer than the reference arrival time. The difference is a negative numerical value when the arrival time is shorter than the reference arrival time. Therefore, the second difference Δt2 shown in FIG. 3 and the third difference Δt3 shown in FIG. 4 are positive numerical values. The fourth difference Δt4 shown in FIG. 5 is a negative numerical value.

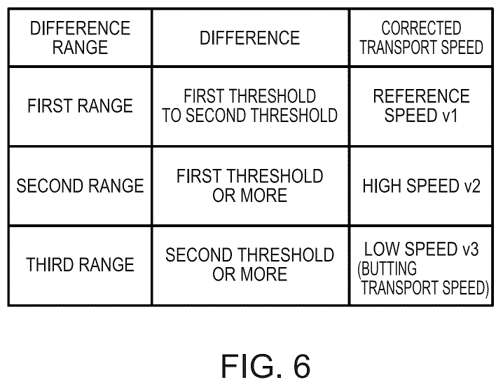

As shown in FIG. 6, the differences are assigned to difference ranges. The difference range includes a plurality of ranges. The difference range may include a first range, a second range, and a third range.

The first range is a range in which the difference is smaller than a first threshold value and larger than a second threshold value. The second range is a range in which the difference is equal to or larger than the first threshold value. The third range is a range in which the difference is equal to or less than the second threshold value. The first threshold is larger than the second threshold. The first threshold value may be a positive numerical value, and the second threshold value may be a negative numerical value.

When the difference is included in the first range, the reference speed v1 is selected as the corrected transport speed. When the difference is included in the second range, the high speed v2 is selected as the corrected transport speed. When the difference is included in the third range, the low speed v3 is selected as the corrected transport speed.

The corrected transport time is controlled so that the medium 99 can be transported to the third transport section 23 at an appropriate timing by reducing the difference. It is preferable that the corrected transport time is controlled so that the difference is eliminated and the medium 99 can be transported to the third transport section 23 at an appropriate timing. In particular, the corrected transport time is controlled based on the difference so that the leading end of the medium 99 is detected by the second medium detection section 42 at a predetermined second detection timing. The second detection timing is a timing indicated by a reference numeral T17 shown in FIGS. 2 to 5.

As shown in FIGS. 2 to 5, in the present embodiment, the transport speed of the medium 99 by the second transport section 22 is controlled in the same manner in the first acceleration period T1 and the second deceleration period T7 regardless of the difference. In the present embodiment, at the timing indicated by the reference numeral T17, the transport speed of the medium 99 by the second transport section 22 is controlled so that the leading end of the medium 99 is detected at the detection position by the second medium detection section 42 in the same manner regardless of the difference.

### Transport Data Control Process

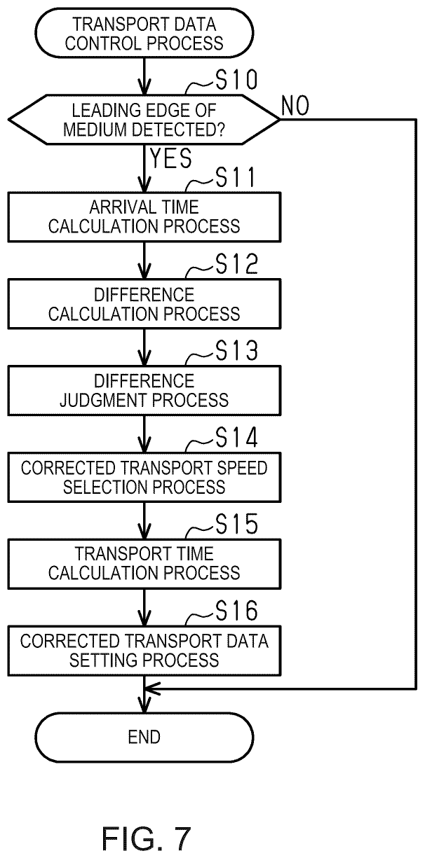

Next, a transport data control process will be described with reference to FIG. 7. The transport data control process is executed by the control section 17 at predetermined intervals.

As shown in FIG. 7, in step S10, the control section 17 determines whether or not the leading end of the medium 99 is detected at a predetermined position based on the detection signal from the first medium detection section 41. When the control section 17 determines that the leading end of the medium 99 is not detected at the predetermined position, the control section 17 ends the transport data control process. When the control section 17 determines that the leading end of the medium 99 is detected at the predetermined position, the control section 17 shifts the processing to step S11.

In step S11, the control section 17 executes an arrival time calculation process. In this process, the control section 17 calculates the time elapsed from the start of the transport of the medium 99 as the arrival time. Accordingly, the control section 17 can calculate the arrival time of the medium 99 at the predetermined position after the start of the transport of the medium 99. The control section 17 stores the arrival time in the memory.

In step S12, the control section 17 executes a difference calculation process. In this process, the control section 17 reads the reference arrival time stored in advance in the memory. The control section 17 calculates the difference between the calculated arrival time and the reference arrival time. Accordingly, the control section 17 can calculate the difference between the arrival time of the medium 99 at the predetermined position and the reference arrival time. The control section 17 stores the difference in the memory.

In step S13, the control section 17 executes a difference judgment process. In this process, the control section 17 refers to difference ranges stored in advance in the memory, and specifies the difference range that includes the difference calculated in step S12.

Specifically, when the difference is smaller than the first threshold and larger than the second threshold, the control section 17 specifies that the difference is included in the first range. When the difference is equal to or larger than the first threshold, the control section 17 determines that the difference is included in the second range. When the difference is equal to or less than the second threshold, the control section 17 specifies that the difference is included in the third range.

In step S14, the control section 17 executes a corrected transport speed selection process. In this process, the control section 17 selects a corrected transport speed corresponding to a difference range including the difference from a plurality of types of corrected transport speeds.

Specifically, when the difference is included in the first range, the control section 17 selects the reference speed v1 from the plurality of types of corrected transport speeds. When the difference is included in the second range, the control section 17 selects the high speed v2 from the plurality of types of corrected transport speeds. When the difference is included in the third range, the control section 17 selects the low speed v3 from the plurality of types of corrected transport speeds.

In this manner, the control section 17 selects the transport speed of the medium 99 by the second transport section 22 from a plurality of types of corrected transport speeds determined in advance based on the difference between the arrival time of the medium 99 at the predetermined position and the reference arrival time.

In step S15, the control section 17 executes a transport time calculation process. In this process, the control section 17 calculates the corrected transport time based on the difference calculated in step S12 and the corrected transport speed selected in step S14 so that the second detection timing by the second medium detection section 42 becomes a predetermined time.

Specifically, the control section 17 calculates the adjustment target time based on the differences calculated in step S12. The adjustment target time is a time from the actual arrival time at the predetermined position to the arrival time at the detection position.

The control section 17 calculates the normal transport time, the corrected transport time, and the butting transport time based on the difference calculated in step S12, the corrected transport speed selected in step S14, and the calculated adjustment target time. The normal transport time is the transport time for transporting the medium 99 at the normal transport speed v0. The butting transport time is the transport time for transporting the medium 99 at the butting transport speed v3.

In particular, when the corrected transport speed is not the low speed v3, the control section 17 calculates the normal transport time, the corrected transport time, and the butting transport time based also on the second acceleration period T3 and the first deceleration period T5.

The control section 17 calculates the normal transport time, the corrected transport time, and the butting transport time so as to transport the medium 99 from the predetermined position to the detection position from the actual arrival time to the predetermined second detection timing. The control section 17 calculates the normal transport time, the corrected transport time, and the butting transport time so that the sum of the normal transport time, the corrected transport time, the butting transport time, the time of the second acceleration period T3, and the time of the first deceleration period T5 becomes the adjustment target time.

As the time of the second acceleration period T3, times corresponding to the speed before acceleration and the speed after acceleration are stored in the memory. As the first deceleration period T5, times corresponding to the speed before deceleration and the speed after deceleration are stored in the memory. As the distances by which the medium 99 is transported in the second acceleration period T3, distances corresponding to the speed before acceleration and the speed after acceleration are stored in the memory. As the distances by which the medium 99 is transported in the first deceleration period T5, distances corresponding to the speed before deceleration and the speed after deceleration are stored in the memory.

When the corrected transport speed is the low speed v3, the control section 17 calculates the normal transport time, the corrected transport time, and the butting transport time based also on the second acceleration period T3. In this case, the corrected transport time is the transport time at the butting transport speed v3.

During a timing from the actual arrival time to the predetermined second detection timing, the control section 17 calculates the normal transport time and the butting transport time so as to transport the medium 99 from the predetermined position to the detection position. The butting transport time includes the corrected transport time. The control section 17 calculates the normal transport time and the butting transport time such that the sum of the normal transport time, the butting transport time, and the time of the second acceleration period T3 becomes the adjustment target time.

As the time of the second acceleration period T3, times corresponding to the speed before acceleration and the speed after acceleration are stored in the memory. As the distances by which the medium 99 is transported in the second acceleration period T3, distances corresponding to the speed before acceleration and the speed after acceleration are stored in the memory.

The control section 17 calculates the normal transport period T2, the second acceleration period T3, the corrected transport period T4, the first deceleration period T5, and the butting transport period T6 based on the calculated normal transport time, the corrected transport time, and the butting transport time. In particular, when the corrected transport speed is the low speed v3, the control section 17 calculates the normal transport period T2, the second acceleration period T3, and the butting transport period T6 based on the calculated normal transport time and butting transport time.

The control section 17 may determine the normal transport time, the corrected transport time, and the butting transport time based on the lower limit time of the normal transport time. The lower limit time of the normal transport time is defined such that the medium 99 is transported continuously at the normal transport period T2 from the start of the normal transport speed v0 until after the reference arrival time. The lower limit time of the normal transport time may be equal to or longer than the time until the transport of the preceding sheet of medium 99 by the second transport section 22 is completed. Accordingly, the control section 17 can cause the second transport section 22 to transport the preceding sheet of medium 99 and the subsequent sheet of medium 99 at the normal transport speed v0 until the transport of the preceding sheet of medium 99 by the second transport section 22 is completed.

In step S16, the control section 17 executes a corrected transport data setting process. In this process, the control section 17 generates the corrected transport data for causing the second transport section 22 to transport the medium 99 based on the corrected transport speed selected in step S14 and the various transport times and periods determined in step S15. The control section 17 sets the generated corrected transport data in the memory.

### Transport Control Process

Next, the transport control process will be described. The transport control process is executed by the control section 17 when the transport of the medium 99 is started.

In this process, when the transport of the medium 99 is started, the control section 17 controls the first transport section 21 to feed the medium 99 from the medium accommodation section 12. When the transport of the medium 99 is started, the control section 17 controls the second transport section 22 based on the transport data stored in the memory. When the transport of the medium 99 is started, the control section 17 starts counting for calculating the arrival time.

The transport data includes normal transport data and corrected transport data. The normal transport data is transport data in which the medium 99 is not transported at the corrected transport speed. The normal transport data may be transport data for transporting the medium 99 at the normal transport speed v0 and then transporting the medium 99 at the butting transport speed v3. The normal transport data may be transport data including the first acceleration period T1, the normal transport period T2, the second acceleration period T3, the butting transport period T6, and the second deceleration period T7.

The control section 17 controls the second transport section 22 based on the normal transport data when transport of the medium 99 is started. The control section 17 executes the transport data control process, sets the corrected transport data in the memory, and then transports the medium 99 based on the corrected transport data instead of the normal transport data.

Accordingly, the control section 17 changes the transport speed by the second transport section 22 in the order of the normal transport speed v0, the corrected transport speed, and the butting transport speed v3 for each of the medium 99 transported on the transport path 15. In particular, when the corrected transport speed based on the corrected transport data is the low speed v3, the control section 17 changes the transport speed by the second transport section 22 in the order of the normal transport speed v0 and the butting transport speed v3 because the low speed v3 and the butting transport speed v3 are equal to each other.

In this way, the control section 17 controls the second transport section 22 to transport the medium 99 at the normal transport speed v0 during the normal transport period T2 that is not the corrected transport period T4. The control section 17 controls the second transport section 22 to transport the medium 99 at the corrected transport speed in the corrected transport period T4 based on the corrected transport time. The control section 17 performs control such that the medium 99 is transported by the second transport section 22 in the butting transport period T6 at the butting transport speed v3.

In particular, when plural sheets of medium 99 including a preceding sheet of medium 99 and a subsequent sheet of medium 99 are transported along the transport path 15, the normal transport period T2 includes a period in which the trailing end of the preceding sheet of medium 99 is transported by the second transport section 22 and the transport of the subsequent sheet of medium 99 is started. In this manner, in the normal transport period T2, the second transport section 22 transports both the preceding sheet of medium 99 and the subsequent sheet of medium 99.

In the normal transport period T2, the transport of the preceding sheet of medium 99 by the second transport section 22 is completed. That is, before the corrected transport period T4, the transport of the preceding sheet of medium 99 by the second transport section 22 is completed. As described above, in the corrected transport period T4, the second transport section 22 transports the subsequent sheet of medium 99 after the transport of the preceding sheet of medium 99 is completed.

Accordingly, the control section 17 performs control such that the second transport section 22 transports the preceding sheet of medium 99 and the subsequent sheet of medium 99 at the normal transport speed v0 in a period in which the trailing end of the preceding sheet of medium 99 is transported by the second transport section 22. The control section 17 performs control such that the second transport section 22 transports the subsequent sheet of medium 99 at the corrected transport speed after the transport of the preceding sheet of medium 99 by the second transport section 22 is completed.

The control section 17 controls the second transport section 22 so as to perform curvilinear acceleration and deceleration when changing the transport speed of the second transport section 22. That is, the control section 17 performs curvilinear drive, which is curvilinear acceleration and deceleration, instead of trapezoidal drive and triangular drive, which are linear acceleration and deceleration. The curvilinear drive is performed by changing the rate of change of acceleration and deceleration, instead of keeping the rate of change of acceleration and deceleration constant.

In such a case, the control section 17 reads an acceleration transport pattern from the memory and controls the second transport section 22 so as to perform curvilinear acceleration. The control section 17 reads a deceleration transport pattern from the memory and controls the second transport section 22 so as to perform curvilinear deceleration.

The acceleration transport patterns include a transport pattern for accelerating the transport speed of the second transport section 22 from 0 to the normal transport speed v0. The acceleration transport patterns include a transport pattern for accelerating the transport speed of the second transport section 22 from the normal transport speed v0 to the reference speed v1. The acceleration transport patterns include a transport pattern for accelerating the transport speed of the second transport section 22 from the normal transport speed v0 to the high speed v2. The acceleration transport patterns include a transport pattern for accelerating the transport speed of the second transport section 22 from the normal transport speed v0 to the low speed v3.

The decelerated transport patterns include a transport pattern for decelerating the transport speed of the second transport section 22 from the reference speed v1 to the butting transport speed v3. The decelerated transport patterns include a transport pattern for decelerating the transport speed of the second transport section 22 from the high speed v2 to the butting transport speed v3. The deceleration transport patterns include a transport pattern for decelerating the transport speed of the second transport section 22 from the butting transport speed v3 to 0.

In this way, by performing control so as to select any one of a plurality of types of corrected transport speeds, it is also possible to reduce the number of acceleration and deceleration transport patterns. This makes it possible to suppress an increase in the storage capacity of the memory.

### Specific Example of Control Content of Second Transport Section 22

Next, a specific example of the control content of the second transport section 22 will be described with reference to FIGS. 2 to 5.

As shown in FIG. 2, when the transport of the medium 99 is started at the timing indicated by the reference numeral T10, the first acceleration period T1 is reached, and the transport speed by the second transport section 22 is accelerated from 0 to the normal transport speed v0. In this case, curvilinear acceleration is performed. At the timing indicated by the reference numeral T11, the normal transport period T2 is reached, and the transport speed of the second transport section 22 is maintained at the normal transport speed v0.

When the leading end of the medium 99 is detected by the first medium detection section 41 at the timing indicated by the reference numeral T12, the arrival time from the start of the transport of the medium 99 is the reference arrival time. At this time, the difference is 0. Accordingly, the reference speed v1 is selected from the plurality of corrected transport speeds, and then the first time t1 is determined as the corrected transport time. The start timing of the second acceleration period T3, the start timing of the corrected transport period T4, and the start timing of the first deceleration period T5 are determined based on the corrected transport time.

At the timing indicated by the reference numeral T13, the second acceleration period T3 is reached, and the transport speed of the second transport section 22 is accelerated from the normal transport speed v0 to the reference speed v1. In this case, curvilinear acceleration is performed. At the timing indicated by the reference numeral T14, the corrected transport period T4 is reached, and the transport speed of the second transport section 22 is maintained at the reference speed v1.

At the timing indicated by the reference numeral T15, the first time t1 elapses from the timing indicated by the reference numeral T14, the first deceleration period T5 starts, and the transport speed of the second transport section 22 decelerates from the reference speed v1 to the butting transport speed v3. In this case, curvilinear deceleration is performed. At the timing indicated by the reference numeral T16, the butting transport period T6 is reached, and the transport speed of the second transport section 22 is maintained at the butting transport speed v3. Accordingly, the leading end of the medium 99 is detected by the second medium detection section 42 at a certain timing indicated by the reference numeral T17.

At the timing indicated by the reference numeral T18, the second deceleration period T7 is reached, and the transport speed of the second transport section 22 is decelerated from the butting transport speed v3 to 0. In this case, curvilinear deceleration is performed. At the timing indicated by the reference numeral T19, the transport speed of the second transport section 22 becomes 0.

As shown in FIG. 3, after the reference arrival time is reached, the leading end of the medium 99 may be detected by the first medium detection section 41 at the timing indicated by the reference numeral T22. In this case, the difference becomes the second difference Δt2. The second difference Δt2 is included in the first range. Accordingly, after the reference speed v1 is selected from the plurality of corrected transport speeds, the second time t2 is determined as the corrected transport time. The second time t2 is longer than the first time t1.

At the timing indicated by the reference numeral T23, the second acceleration period T3 is reached, and the transport speed of the second transport section 22 is accelerated from the normal transport speed v0 to the reference speed v1. In this case, curvilinear acceleration is performed. At the timing indicated by the reference numeral T24, the corrected transport period T4 is reached, and the transport speed of the second transport section 22 is maintained at the reference speed v1.

At the timing indicated by the reference numeral T15, the second time t2 elapses from the timing indicated by the reference numeral T24, the first deceleration period T5 starts, and the transport speed of the second transport section 22 decelerates from the reference speed v1 to the butting transport speed v3. In this case, the leading end of the medium 99 is detected by the second medium detection section 42 at a constant timing indicated by the reference numeral T17.

As shown in FIG. 4, after the reference arrival time is reached, the leading end of the medium 99 may be detected by the first medium detection section 41 at the timing indicated by the reference numeral T32. In this case, the difference is the third difference Δt3. The third difference Δt3 is included in the second range. Accordingly, after the high speed v2 is selected from the plurality of corrected transport speeds, the third time t3 is determined as the corrected transport time.

At the timing indicated by the reference numeral T33, the second acceleration period T3 is reached, and the transport speed of the second transport section 22 is accelerated from the normal transport speed v0 to the high speed v2. In this case, curvilinear acceleration is performed. At the timing indicated by the reference numeral T34, the corrected transport period T4 is reached, and the transport speed of the second transport section 22 is maintained at the high speed v2.

At the timing indicated by the reference numeral T35, the third time t3 elapses from the timing indicated by the reference numeral T34, the first deceleration period T5 starts, and the transport speed of the second transport section 22 is decelerated from the high speed v2 to the butting transport speed v3. In this case, curvilinear deceleration is performed. At the timing indicated by the reference numeral T36, the butting transport period T6 is reached, and the transport speed of the second transport section 22 is maintained at the butting transport speed v3. In this case, the leading end of the medium 99 is detected by the second medium detection section 42 at a constant timing indicated by the reference numeral T17.

As shown in FIG. 5, there is a case where the leading end of the medium 99 is detected by the first medium detection section 41 at a timing indicated by a reference numeral T42 before the reference arrival time. In this case, the difference becomes the fourth difference Δt4. The fourth difference Δt4 is included in the third range. Thus, after the low speed v3 is selected from the plurality of corrected transport speeds, the fourth time t4 is determined as the total time of the corrected transport time and the butting transport time. The butting transport time is a time for transporting the medium 99 at the butting transport speed v3.

At the timing indicated by the reference numeral T43, the second acceleration period T3 is reached, and the transport speed of the second transport section 22 is accelerated from the normal transport speed v0 to the low speed v3. That is, the transport speed is accelerated from the normal transport speed v0 to the butting transport speed v3. In this case, curvilinear acceleration is performed. At the timing indicated by the reference numeral T44, the butting transport period T6 is reached, and the transport speed of the second transport section 22 is maintained at the butting transport speed v3. The butting transport period T6 includes the corrected transport period T4. In this case, the leading end of the medium 99 is detected by the second medium detection section 42 at a constant timing indicated by the reference numeral T17.

### Operation and Effects of the First Embodiment

The operation and effects of the first embodiment will be described.
(1-1) The control section 17 selects the transport speed of the medium 99 by the second transport section 22 from a plurality of types of predetermined corrected transport speeds based on the difference between the arrival time of the medium 99 at the predetermined position and the reference arrival time. The control section 17 calculates a corrected transport time for transporting the medium 99 at the corrected transport speed based on the difference and the selected corrected transport speed. According to this configuration, acceleration and deceleration corresponding to the selected corrected transport speed can be smoothly performed, and the medium 99 can be transported at an appropriate timing by adjusting the corrected transport speed. In particular, even when there is a deviation in the transport time of the medium 99 by the first transport section 21, the medium 99 can be transported at an appropriate timing, and the feeding timing of the medium 99 by the first transport section 21 can have a degree of freedom. Therefore, when the transport speed is corrected, it is possible to suppress complication of calculation of the corrected transport speed. Therefore, it is possible to improve the performance of transporting the medium 99. In this way, by improving the performance in transporting the medium 99, it is possible to perform recording on the medium 99 at an appropriate timing.

In addition, the medium 99 that has reached the predetermined position can be transported at the corrected transport speed based on the difference. Therefore, it is possible to improve the performance of transporting the medium 99.
(1-2) The corrected transport speed includes a reference speed v1 based on the reference arrival time, a high speed v2 faster than the reference speed v1, and a low speed v3 slower than the reference speed v1. According to this configuration, the corrected transport speed can be controlled not only to the reference speed v1 based on the reference arrival time, but also to the high speed v2 higher than the reference speed v1 and the low speed v3 lower than the reference speed v1. In this manner, by providing the corrected transport speed with diversity, the transport speed of the medium 99 can be corrected in both cases where the medium 99 reaches at the predetermined position early and a case where the medium 99 reaches at the predetermined position late. Therefore, it is possible to improve the performance of transporting the medium 99.
(1-3) The control section 17 causes the second transport section 22 to transport the medium 99 at the normal transport speed v0 in the normal transport period T2. The control section 17 causes the second transport section 22 to transport the medium 99 at the corrected transport speed in the corrected transport period T4. According to this configuration, the transport speed by the second transport section 22 can be made different in the corrected transport period T4 and the normal transport period T2. In this manner, by providing the diversity of the transport speed, the transport speed of the medium 99 can be corrected. Therefore, it is possible to improve the performance of transporting the medium 99.
(1-4) The normal transport speed v0 is equal to the transport speed at which the medium 99 is transported by the third transport section 23. The control section 17 causes the second transport section 22 to transport the preceding sheet of medium 99 and the subsequent sheet of medium 99 at the normal transport speed v0 in a period in which the trailing end of the preceding sheet of medium 99 is transported by the second transport section 22. After the transport of the preceding sheet of medium 99 by the second transport section 22 is completed, the control section 17 causes the second transport section 22 to transport the subsequent sheet of medium 99 at the corrected transport speed. According to this configuration, in the period in which the trailing end of the preceding sheet of medium 99 is transported by the second transport section 22, the preceding sheet of medium 99 and the subsequent sheet of medium 99 can be transported by the second transport section 22 at the same normal transport speed v0 as that of the third transport section 23. Accordingly, the preceding sheet of medium 99 can be smoothly transported between the second transport section 22 and the third transport section 23. In particular, the recording section 16 is configured to perform recording on the medium 99 transported by the third transport section 23. Therefore, by smoothly transporting the preceding sheet of medium 99 between the second transport section 22 and the third transport section 23, it is possible to improve the accuracy of recording. In addition, after the transport of the preceding sheet of medium 99 by the second transport section 22 is completed, the subsequent sheet of medium 99 can be transported by the second transport section 22 at the corrected transport speed. Accordingly, the subsequent sheet of medium 99 can be transported at the corrected transport speed by the second transport section 22. Therefore, it is possible to improve the performance of transporting the medium 99.
(1-5) The normal transport speed v0 is lower than the corrected transport speed. According to this configuration, after the transport of the preceding sheet of medium 99 by the second transport section 22 is completed, the subsequent sheet of medium 99 can be transported by the second transport section 22 at the corrected transport speed higher than the normal transport speed v0. Accordingly, the transport speed of the subsequent sheet of medium 99 can be increased by the second transport section 22. In this way, the throughput of the medium 99 can be improved. Therefore, it is possible to improve the performance of transporting the medium 99.
(1-6) The first transport section 21 is a feeding section that feeds the medium 99 accommodated in the medium accommodation section 12. The normal transport speed v0 is equal to or higher than the transport speed of the first transport section 21. According to this configuration, the medium 99 can be fed at an appropriate transport speed, and even in a case where the transport speed by the first transport section 21 is decreased, the transport speed can be increased by the second transport section 22. Accordingly, the transport speed of the medium 99 can be increased by the second transport section 22. In this way, the throughput of the medium 99 can be improved. Therefore, it is possible to improve the performance of transporting the medium 99. In addition, it is possible to suppress the medium 99 transported by the first transport section 21 from catching up with the medium 99 transported by the second transport section 22.
(1-7) The normal transport speed v0 is lower than the butting transport speed v3 and the low speed v3. The control section 17 changes the transport speed of the second transport section 22 in the order of the normal transport speed v0, the corrected transport speed, and the butting transport speed v3. According to this configuration, the medium 99 can be butted with the registration roller pair 35 at an appropriate transport speed. In addition, by changing the transport speed of the second transport section 22 in the order of the normal transport speed v0, the corrected transport speed, and the butting transport speed v3, the medium 99 can be transported at a transport speed according to the situation. Therefore, it is possible to improve the performance of transporting the medium 99.
(1-8) The reference speed v1 is higher than the transport speed of the first transport section 21. According to this configuration, even when the transport speed of the first transport section 21 is decreased, the transport speed can be increased by the second transport section 22. Accordingly, the transport speed of the medium 99 can be increased by the second transport section 22. In this way, the throughput of the medium 99 can be improved. Therefore, it is possible to improve the performance of transporting the medium 99.
(1-9) The low speed v3 is equal to the butting transport speed v3. According to this configuration, the medium 99 can be butted with the registration roller pair 35 at an appropriate transport speed. In addition, the number of times of changing the transport speed can be reduced by setting the corrected transport speed by the second transport section 22 to the low speed v3 equal to the butting transport speed v3. Therefore, it is possible to improve the performance of transporting the medium 99.
(1-10) The control section 17 controls the second transport section 22 so as to perform curvilinear acceleration and deceleration. According to this configuration, the medium 99 can be transported so as to be accelerated and decelerated in a curvilinear manner. Therefore, it is possible to improve the performance of transporting the medium 99.

### SECOND EMBODIMENT

Next, a second embodiment will be described. In the following description, redundant descriptions of configurations identical to those of the previously described embodiment will be omitted or simplified, and configurations that differ from the previously described embodiment will be detailed.

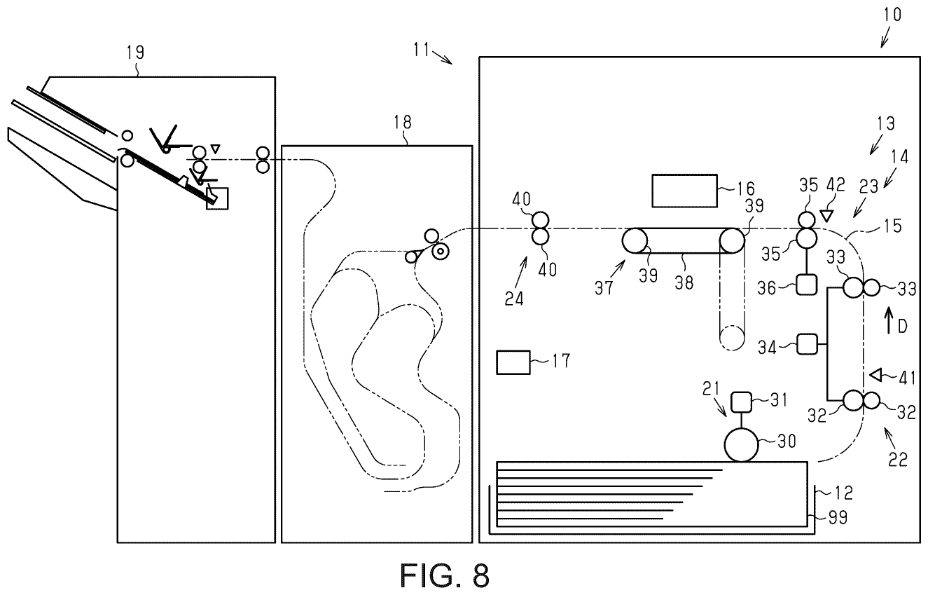

As illustrated in FIG. 8, in the second embodiment, the medium transport device 13 may be adopted in the recording system 10. The recording system 10 includes a recording device 11, an intermediate device 18, and a post-processing device 19. That is, the recording system 10 includes the medium transport device 13.

The intermediate device 18 is a device that transports the medium 99 that was recorded on by the recording section 16 from the recording device 11 to the post-processing device 19. The intermediate device 18 may reverse the medium 99 and transport the medium 99 to the post-processing device 19.

The post-processing device 19 is a device that performs post-processing on the medium 99 that was recorded on by the recording section 16. The post-processing device 19 corresponds to an example of a post-processing section. The post-processing device 19 may be controlled by the control section 17 of the recording device 11, but may be controlled by a control section of the post-processing device 19. In such a case, the recording system 10 may include at least one control section, and both the recording device 11 and the post-processing device 19 may include control sections.

The post-processing may be, for example, binding processing, but may be punching processing, folding processing, shift processing, or bar stacking processing, in addition to the binding processing. The binding process is a process in which plural sheets of the medium 99 are bound and then discharged. The punching process is a process in which one or more sheets of medium 99 are punched and then discharged. The folding process is a process in which the medium 99 is folded and then discharged. The shift process is a process in which the position of the medium 99 is shifted for each unit of sheets and then discharged. The bar stacking process is a process of discharging sheets of the medium 99 as a medium bundle without shifting the position of plural sheets of the medium 99 in bundle units and a process of discharging a single sheet of the medium 99 without shifting the medium 99.

### Operations and Effects of Second Embodiment

Operations and effects of the second embodiment will be described.
(2-1) The recording system 10 includes the post-processing device 19 that performs post-processing on the medium 99 that was recorded on by the recording section 16. According to this configuration, by improving the performance in transporting the medium 99, it is possible to perform post-processing on the medium 99 at an appropriate timing.

### THIRD EMBODIMENT

Next, a third embodiment will be described. In the third embodiment, the transport path 15 is longer than that in the first embodiment.

### Configuration of Recording Device 11

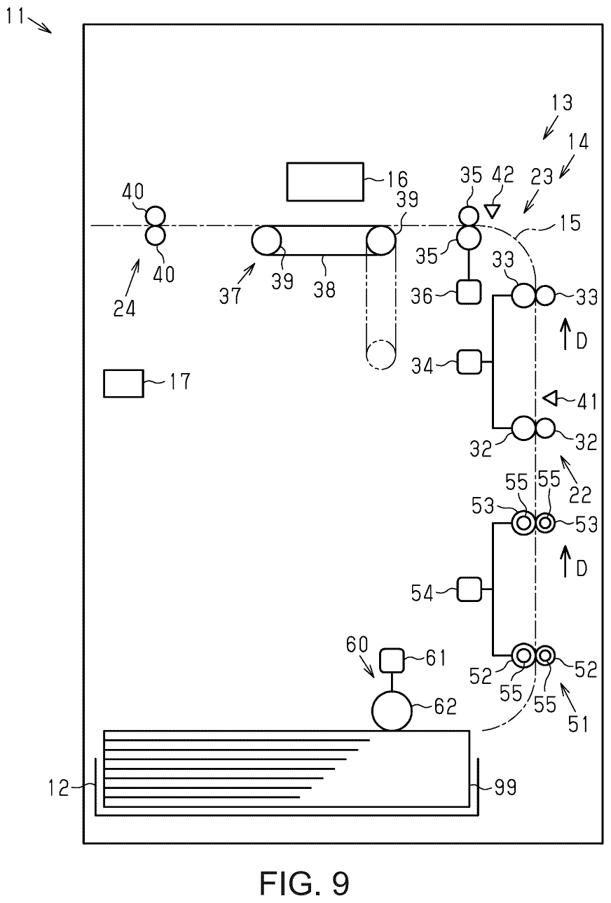

As illustrated in FIG. 9, in the third embodiment, the transport section 14 may include a feeding section 60 and a first transport section 51. That is, the recording device 11 and the medium transport device 13 may include the feeding section 60 and the first transport section 51. The feeding section 60 is the first transport section 21 in the first embodiment and the second embodiment. The feeding section 60 includes a feeding drive section 61 and a feed roller 62. The feeding drive section 61 is the first transport drive section 31 in the first embodiment and the second embodiment. The feed roller 62 is the feed roller 30 in the first embodiment and the second embodiment.

The first transport section 51 may be configured to transport the medium 99 fed from the feeding section 60 to the second transport section 22. The first transport section 51 may not be located at the most upstream position of the transport path 15. In this case, the first transport section 51 is located downstream of the feeding section 60 in the transport path 15.

The first transport section 51 includes a first upstream roller pair 52, a second upstream roller pair 53, and a first transport drive section 54. The second upstream roller pair 53 is located downstream of the first upstream roller pair 52. The first transport drive section 54 is connected to the first upstream roller pair 52. The first transport drive section 54 is connected to the second upstream roller pair 53. The first transport drive section 54 is a drive source that rotates the first upstream roller pair 52 and the second upstream roller pair 53. The first transport drive section 54 may be a motor.

The first transport drive section 54 is driven based on a drive signal from the control section 17, thereby rotating the first upstream roller pair 52 and the second upstream roller pair 53. The first transport drive section 54 rotates the first upstream roller pair 52 and the second upstream roller pair 53 so as to transport the medium 99 in the transport direction D.

The first upstream roller pair 52 may include a switching section 55. The second upstream roller pair 53 may include a switching section 55. That is, the first transport section 51 may include the switching section 55. The switching section 55 may be, for example, a one way clutch.

The switching section 55 allows the first upstream roller pair 52 to rotate in a direction in which the medium 99 is transported to the second transport section 22. The switching section 55 allows the second upstream roller pair 53 to rotate in a direction in which the medium 99 is transported to the second transport section 22.

The switching section 55 is switchable between a driving state and a driven state. Specifically, the driving state is a state in which the first upstream roller pair 52 and the second upstream roller pair 53 are rotated by drive force transmitted from the first transport drive section 54. That is, the driving state is a state in which the first upstream roller pair 52 and the second upstream roller pair 53 rotate at a speed controlled by the control section 17. The driven state is a state in which the drive force from the first transport drive section 54 is not transmitted and the medium 99 can be driven by a frictional force with the medium 99 transported by the second transport section 22. That is, the driven state is a state in which the rotation is driven by the medium 99.

The switching section 55 prevents the first upstream roller pair 52 from rotating in a direction opposite to the direction in which the medium 99 is transported to the second transport section 22. The second upstream roller pair 53 is prevented from rotating in a direction opposite to the direction in which the medium 99 is transported to the second transport section 22 by the switching section 55.

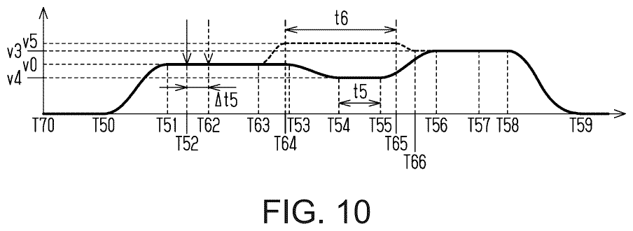

Control contents of first transport section 51 and second transport section 22 In the third embodiment, the corrected transport speed includes a reference speed v4 illustrated in FIG. 10 and a high speed v5 illustrated in FIG. 10. The reference speed v4 is lower than the normal transport speed v0. The reference speed v4 is lower than the butting transport speed v3. The high speed v5 is higher than the normal transport speed v0. The high speed v5 is higher than the butting transport speed v3.

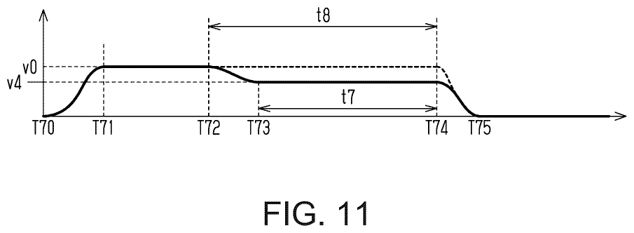

Next, a specific example of the control contents of the first transport section 51 and the second transport section 22 will be described with reference to FIGS. 10 and 11. FIG. 10 is a specific example of the control content of the second transport section 22. FIG. 11 is a specific example of the control content of the first transport section 51.

As illustrated in FIG. 10, when the feeding section 60 and the first transport section 51 start transporting the medium 99 at the timing indicated by the reference numeral T70, the second transport section 22 starts transporting the medium 99 at the timing indicated by the reference numeral T50. Thereafter, the transport speed of the second transport section 22 is increased in a curvilinear manner, and the transport speed of the second transport section 22 is maintained at the normal transport speed v0 at the timing indicated by the reference numeral T51.

When the leading end of the medium 99 is detected by the first medium detection section 41 at the timing indicated by the reference numeral T52, which is the reference arrival time, the difference between the arrival time and the reference arrival time is 0. Accordingly, the reference speed v4 is selected from the plurality of corrected transport speeds, and then the fifth time t5 is determined as the corrected transport time. Each timing to start the adjustment of the transport speed may be determined based on the corrected transport time.

At the timing indicated by the reference numeral T53, the transport speed of the second transport section 22 is decelerated in a curvilinear manner, and is maintained at the reference speed v4 at the timing indicated by the reference numeral T54.

At the timing indicated by reference numeral T55, when the fifth time t5 has elapsed from the timing indicated by reference numeral T54, the transport speed by the second transport section 22 is accelerated in a curvilinear manner, and is maintained at the butting transport speed v3 at the timing indicated by reference numeral T56. Accordingly, the leading end of the medium 99 is detected by the second medium detection section 42 at a certain timing indicated by the reference numeral T57. At the timing indicated by the reference numeral T58, the transport speed of the second transport section 22 is decelerated in a curvilinear manner, and at the timing indicated by the reference numeral T59, the transport speed of the second transport section 22 becomes 0.

As illustrated in FIG. 11, when the feeding section 60 starts transporting the medium 99 at the timing indicated by the reference numeral T70, the first transport section 51 starts transporting the medium 99 at the timing indicated by the reference numeral T71. Thereafter, the transport speed of the first transport section 51 is increased in a curvilinear manner, and is maintained at the normal transport speed v0 at the timing indicated by the reference numeral T71. The normal transport speed v0 corresponds to an example of a predetermined transport speed.

When the reference speed v4 is selected as the corrected transport speed in the second transport section 22, the control section 17 controls the transport speed of the first transport section 51 to decelerate in a curvilinear manner at the timing indicated by the reference numeral T72 and to be maintained at the reference speed v4 at the timing indicated by the reference numeral T73. The control section 17 drives the first transport section 51 at the reference speed v4 for the seventh time t7. The seventh time t7 may be a value used when the first transport section 51 is driven at the corrected transport speed.

When the seventh time t7 has elapsed from the time indicated by reference numeral T73, at the timing indicated by reference numeral T74, the control section 17 decelerates the transport speed of the first transport section 51 in a curvilinear manner and sets the transport speed to 0 at the timing indicated by the reference numeral T75.

In this case, the drive force by the first transport drive section 54 is not transmitted to the first upstream roller pair 52 and the second upstream roller pair 53, and the transport speed of the first transport section 51 becomes 0. On the other hand, the first upstream roller pair 52 and the second upstream roller pair 53 themselves are in the driven state, and rotate following the medium 99 transported by the second transport section 22. As described above, the transport speed of the first transport section 51 may not coincide with the rotation speed of the first transport section 51 depending on the medium 99 transported by the second transport section 22, but coincides with the rotation speed of the first transport section 51 in principle.

On the other hand, as illustrated in FIG. 10, when the leading end of the medium 99 is detected by the first medium detection section 41 at the timing indicated by the reference numeral T62 after the reference arrival time is reached, the difference between the arrival time and the reference arrival time is the fifth difference Δt5. In this case, after the high speed v5 is selected from the plurality of corrected transport speeds, the sixth time t6 is determined as the corrected transport time. The sixth time t6 may be longer than the fifth time t5.

At the timing indicated by the reference numeral T63, the transport speed of the second transport section 22 is increased in a curvilinear manner, and at the timing indicated by the reference numeral T64, the transport speed of the second transport section 22 is maintained at the high speed v5.

When the sixth time t6 has elapsed since the time indicated by reference numeral T64, at the timing indicated by reference numeral T65, the transport speed by the second transport section 22 is decelerated in a curvilinear manner, and is maintained at the butting transport speed v3 at the timing indicated by the reference numeral T66.

As illustrated in FIG. 11, when the high speed v5 is selected as the corrected transport speed in the second transport section 22, the control section 17 drives the first transport section 51 for an eighth time t8 while maintaining the normal transport speed v0 at the timing indicated by the reference numeral T72. The eighth time t8 may be a value used when the first transport section 51 is driven at a predetermined transport speed.

When the eighth time t8 has elapsed since the time indicated by the reference numeral T72, at the timing indicated by the reference numeral T74, the control section 17 decelerates the drive speed of the first transport section 51 in a curvilinear manner and sets the drive speed to 0 at the timing indicated by the reference numeral T75.

As described above, when the corrected transport speed is the reference speed v4 after the medium 99 reach the predetermined position, the control section 17 rotates the first transport section 51 at the reference speed v4. That is, when the corrected transport speed is lower than the normal transport speed v0, the control section 17 rotates the first transport section 51 at the reference speed v4.

When the corrected transport speed is the high speed v5 after the medium 99 reach the predetermined position, the control section 17 rotates the first transport section 51 at the normal transport speed v0 as it is. That is, when the corrected transport speed is equal to or higher than the normal transport speed v0, the control section 17 rotates the first transport section 51 at the normal transport speed v0 as it is.

In the third embodiment, the timing indicated by the reference numeral T72 illustrated in FIG. 11 is earlier than the timings indicated by the reference numerals T53 and T63 illustrated in FIG. 10. The timing indicated by the reference numeral T73 illustrated in FIG. 11 is earlier than the timings indicated by the reference numerals T54 and T64 illustrated in FIG. 10, and is earlier than the timings indicated by the reference numerals T53 and T63 illustrated in FIG. 10. In this manner, the change of the transport speed of the first transport section 51 is executed before the change of the transport speed of the second transport section 22. That is, the control section 17 changes the transport speed of the second transport section 22 after changing the transport speed of the first transport section 51.

### Operations and Effects of Third Embodiment

Operations and effects of a third embodiment will be described.
(3-1) When the corrected transport speed is the high speed v5 after the medium 99 reach the predetermined position, the control section 17 rotates the first transport section 51 at the normal transport speed v0. When the corrected transport speed is the reference speed v4 after the medium 99 reaches the predetermined position, the control section 17 rotates the first transport section 51 at the reference speed v4.

According to this configuration, when the corrected transport speed of the second transport section 22 is lower than the normal transport speed v0 in the first transport section 51, the control section 17 can control the transport speed of the first transport section 51 to the reference speed v4, which is the corrected transport speed of the second transport section 22. Therefore, the first transport section 51 can suppress the transport of the trailing end of the medium 99 at a speed higher than that of the leading end of the medium 99 when the medium 99 is transported with respect to the second transport section 22. Accordingly, the first transport section 51 can transport the medium 99 at an appropriate speed with respect to the second transport section 22. Therefore, it is possible to improve the performance of transporting the medium 99.
(3-2) The control section 17 changes the transport speed of the second transport section 22 after changing the transport speed of the first transport section 51. According to this configuration, the control section 17 can change the transport speed of the second transport section 22 according to the transport speed of the first transport section 51. By this, the first transport section 51 can prevent the trailing end of the medium 99 from being transported at a speed higher than that of the leading end of the medium 99 when the medium 99 is transported with respect to the second transport section 22. Therefore, it is possible to improve the performance of transporting the medium 99.

### Modifications

The present embodiment can be implemented with the following modifications. The embodiments and the following modifications can be implemented in combination with each other as long as there is no technical contradiction.
In the second embodiment, the intermediate device 18 may perform post-processing of the medium 99. The recording device 11 may perform post-processing of the medium 99. The post-processing may be processing of inverting and transporting the medium 99. The post-processing may be processing of inverting and transporting the medium 99, but may be, for example, binding processing, punching processing, folding processing, shift processing, or bar stacking processing.
The control section 17 may correct the transport speed of the second transport section 22 when the difference exceeds or falls below the allowable range. When the difference exceed the allowable range, the control section 17 may select the high speed v2 as the corrected transport speed of the second transport section 22. When the difference exceeds the allowable range, the control section 17 may select the reference speed v1 as the corrected transport speed of the second transport section 22 and calculate the corrected transport time. When the difference is below the allowable range, the control section 17 may select the low speed v3 as the corrected transport speed of the second transport section 22. When the difference is below the allowable range, the control section 17 may select the reference speed v1 as the corrected transport speed of the second transport section 22 and calculate the corrected transport time. When the difference is within the allowable range, the control section 17 may select the reference speed v1 as the corrected transport speed of the second transport section 22 and set the corrected transport time to a fixed time. The allowable range may be the first range. The allowable range may be included in the first range.
When the difference is a negative numerical value, the control section 17 may not select the low speed v3 as the corrected transport speed of the second transport section 22. That is, when the difference is a positive numerical value, the control section 17 may select the high speed v2 as the corrected transport speed of the second transport section 22.
When the difference is a positive numerical value, the control section 17 may not select the high speed v2 as the corrected transport speed of the second transport section 22. That is, when the difference is a negative numerical value, the control section 17 may select the low speed v3 as the corrected transport speed of the second transport section 22.
The transport speed of the medium 99 by the registration roller pair 35 and the transport speed of the medium 99 by the medium support section 37 may be different from each other. The normal transport speed v0 may be equal to the transport speed of the medium 99 by the registration roller pair 35, or may be equal to the transport speed of the medium 99 by the medium support section 37.
The control section 17 may control the third transport section 23 to temporarily stop the transport of the medium 99 by the third transport section 23 before recording on the medium 99. The control section 17 may control the third transport section 23 so that the third transport section 23 continuously transports the medium 99.
The low speed v3 may be higher than the butting transport speed v3. The low speed v3 may be lower than the butting transport speed v3. The low speed v3 may be higher than the normal transport speed v0 and lower than the butting transport speed v3. The low speed v3 may be equal to the normal transport speed v0. The butting transport speed v3 may be equal to the normal transport speed v0.
The corrected transport speed may be two types or four or more types of transport speeds. The corrected transport speed may include two or more types of high speeds higher than the reference speed. The corrected transport speed may include two or more types of low speeds lower than the reference speed.
The control section 17 may select a different speed as the corrected transport speed based on the transport condition. The transport condition may include, for example, the size of the medium 99 such as the length of the medium 99 in the transport direction D. The transport condition may include a type of the medium 99 such as plain paper or thick paper. The transport condition may include a position of the medium accommodation section 12 to which the medium 99 is transported among the plurality of medium accommodation sections 12. That is, the transport condition may include the distance from the first transport section 21 to the predetermined position.
The normal transport speed v0 may be higher than the transport speed of the medium 99 by the first transport section 21, may be equal to the transport speed of the medium 99 by the first transport section 21, or may be lower than the transport speed of the medium 99 by the first transport section 21.
The corrected transport data shown in FIG. 2 is predetermined as the normal transport data, and the control section 17 may generate the corrected transport data when the difference is not 0 and control the second transport section 22 based on the corrected transport data as shown in FIGS. 3 to 5.
The control section 17 may execute any process of determining the corrected transport time based on the difference and the corrected transport time. For example, when the control section 17 determines the reference speed v1 as the corrected transport speed, the control section 17 may determine the corrected transport time based on the first time t1, which is the corrected transport time shown in FIG. 2, the difference, and the corrected transport speed. Specifically, the control section 17 specifies the corrected transport distance based on the difference. The corrected transport distance is a transport distance necessary for the leading end of the medium 99 to reach the detection position at a predetermined second detection timing, as compared with the transport data shown in FIG. 2. The control section 17 calculates a time for correcting the first time t1 based on the corrected transport distance and the corrected transport speed. Accordingly, the control section 17 may calculate the corrected transport time based on the first time t1 and the time for correcting to the first time t1.
The second transport drive section 34 may separately include a drive source that rotates the first roller pair 32 and a drive source that rotates the second roller pair 33. The second transport drive section 34 may be a drive source that rotates at least one of the first roller pair 32. The second transport drive section 34 may be a drive source that rotates at least one of the second roller pair 33.
The first transport section 21 may include a separation roller pair in addition to the feed roller 30. The second transport section 22 may include a third roller pair in addition to the first roller pair 32 and the second roller pair 33. The second transport section 22 may include the first roller pair 32 and may not include the second roller pair 33.
The first transport section 21 may not be a feeding section that transports the medium 99 from the medium accommodation section 12. The first transport section 21 may be configured to transport the medium 99 transported from the feeding section. That is, the first transport section 21 may not be located at the most upstream position of the transport path 15. As described above, the arrival time is a time when the leading end of the medium 99 arrives at a predetermined position with reference to the start of the transport of the medium 99, but may be a time when the leading end of the medium 99 arrives at a predetermined position after the leading end of the medium 99 arrives at the predetermined position by the first transport section 21.
The predetermined position may be provided upstream of the first roller pair 32 as long as the predetermined position is downstream of the first transport section 21. The detection position may not be a position at which the leading end of the medium 99 is detected by the second medium detection section 42 as long as the detection position is a specified position downstream of the second transport section 22.
The registration roller pair 35 may be provided between the second transport section 22 and the third transport section 23. In such a case, the third transport section 23 may not include the registration roller pair 35. That is, the second transport section 22, the registration roller pair 35, and the third transport section 23 may be provided in this order from the upstream side to the downstream side.
The second medium detection section 42 may not be provided upstream of the registration roller pair 35 by a slight distance. The medium transport device 13 may not include the registration roller pair 35. In such a case, the second medium detection section 42 may be provided upstream of the third transport section 23.
The third transport section 23 may be provided downstream of the recording section 16. The second transport section 22 may be provided downstream of the recording section 16. The first transport section 21 may be provided downstream of the recording section 16.
The transport section 14 may include a fourth transport section (not illustrated). The fourth transport section may be provided between the first transport section 21 and the second transport section 22. The fourth transport section may be provided between the second transport section 22 and the third transport section 23.
In the third embodiment, in the first upstream roller pair 52, one of the rollers forming the pair may include the switching section 55, or both of the rollers may include the switching section 55. In the second upstream roller pair 53, one of the rollers forming the pair may include the switching section 55, or both of the rollers may include the switching section 55. The first upstream roller pair 52 may not include the switching section 55. The second upstream roller pair 53 may not include the switching section 55.
In the third embodiment, the first roller pair 32 may include the switching section 55. In the third embodiment, the second roller pair 33 may include a switching section 55. In the first roller pair 32, one of the rollers forming the pair may include the switching section 55, or both of the rollers may include the switching section 55. In the second roller pair 33, one of the rollers forming the pair may include the switching section 55, or both of the rollers may include the switching section 55.
In the third embodiment, the transport speed of the first transport section 51 from the position indicated by the reference numeral T72 in FIG. 11 may be higher than the normal transport speed v0. For example, when the corrected transport speed is the high speed v5 after the medium 99 reach the predetermined position, the control section 17 may set the first transport section 51 to the high speed v5. For example, when the corrected transport speed is the high speed v5 after the medium 99 reach the predetermined position, the control section 17 may control the first transport section 51 to be at a speed higher than the normal transport speed v0 and equal to or lower than the high speed v5.
In the third embodiment, the transport speed of the first transport section 51 from the reference numeral T71 in FIG. 11 may be a speed lower than the normal transport speed v0. That is, the predetermined transport speed may be a speed slower than the normal transport speed v0. The transport speed of the first transport section 51 from the reference numeral T71 in FIG. 11 may be a speed higher than the normal transport speed v0. That is, the predetermined transport speed may be a speed higher than the normal transport speed v0.
In the third embodiment, the first transport drive section 54 and the second transport drive section 34 may be controlled via the same control board or may be controlled via different control boards. In a case where the first transport drive section 54 and the second transport drive section 34 are controlled via different control boards, even if an error due to a delay occurs between the control timing of the first transport drive section 54 and the control timing of the second transport drive section 34, the medium 99 can be smoothly transported. In the third embodiment, the first transport section 51 may be controlled by a control section different from the second transport section 22. That is, the recording device 11 and the medium transport device 13 may include a plurality of control sections.
In the third embodiment, the control section 17 may change the transport speed of the second transport section 22 when the transport speed of the first transport section 51 is changed. The control section 17 may change the transport speed of the first transport section 51 after changing the transport speed of the second transport section 22.
In the third embodiment, the recording device 11 may include two or more medium accommodating sections 12. Some of the two or more medium accommodating sections 12 may be provided so as to be able to directly transport the medium 99 to the second transport section 22 without passing through the first transport section 51. In this case, the recording device 11 and the medium transport device 13 may include the same number of feeding sections 60 as the number of medium accommodating sections 12.
In the third embodiment, the recording device 11 and the medium transport device 13 may include two or more first transport sections 51. The recording device 11 and the medium transport device 13 may include two or more first transport sections 51 for one medium accommodating section 12, or may include one or more first transport sections 51 for each of two or more medium accommodating sections 12.
The medium 99 may be a sheet of paper, a film or sheet made of resin, a composite film of resin and metal, a laminate film, a woven fabric, a nonwoven fabric, a metal foil, a metal film, a ceramic sheet, clothing, or the like.
The liquid can be arbitrarily selected as long as the liquid can be attached to the medium 99 to perform recording on the medium 99. For example, the ink includes an ink in which particles of functional material made of solid material such as pigment or metal particles are dissolved, dispersed, or mixed in a solvent, and includes various compositions such as water-based ink, oil-based ink, gel ink, and hot-melt ink.
A lateral printer may be adopted as the recording device 11. The lateral type printer is a printer in which a carriage is movable in two directions of an X axis direction and a Y axis direction. The recording device 11 is not limited to an ink jet printer, and may be a dot impact printer. The recording device 11 may be a laser printer.
The medium transport device 13 may be adopted in the intermediate device 18 other than the recording device 11. The medium transport device 13 may be adopted in the post-processing device 19. The medium transport device 13 may be adopted in an image reading device.
As used herein, the phrase “at least one” means one or more of the desired options. As an example, if the number of options is two, the phrase “at least one” as used herein means only one option or both of the two options. As another example, if the number of options is three or more, the phrase “at least one” as used herein means only one option or a combination of any two or more options.

### Notes

Hereinafter, technical ideas grasped from the above-described embodiment and modifications, and operations and effects thereof will be described. The present technical idea and the operations and effects thereof can be combined with each other within a technically consistent range.
[1] A medium transport device includes a transport section configured to transport a medium and a control section configured to control the transport section, wherein the transport section includes a first transport section configured to transport a medium, and a second transport section configured to transport a medium downstream of the first transport section and the control section selects a transport speed of the medium by the second transport section from a plurality of types of predetermined corrected transport speeds based on a difference between an arrival time of the medium at a predetermined position downstream of the first transport section and a reference arrival time, and calculates a corrected transport time for transporting the medium at the corrected transport speed based on the difference and the selected corrected transport speed.

According to this configuration, the transport speed of the medium by the second transport section can be selected from a plurality of types of predetermined corrected transport speeds based on the difference between the arrival time of the medium at the predetermined position and the reference arrival time. Thereafter, the corrected transport time for transporting the medium at the corrected transport speed can be calculated based on the difference and the corrected transport speed. Accordingly, it is possible to smoothly perform acceleration and deceleration corresponding to the selected corrected transport speed, and it is possible to transport the medium at an appropriate timing by adjusting the corrected transport speed. Therefore, when the transport speed is corrected, it is possible to suppress complication of calculation of the corrected transport speed. Therefore, it is possible to improve the performance in transporting the medium.

In addition, the medium that has reached the predetermined position can be transported at the corrected transport speed based on the difference between the arrival time and the reference arrival time. Therefore, it is possible to improve the performance in transporting the medium.
[2] The medium transport device described above, the corrected transport speed may include a reference speed based on the reference arrival time, a high speed higher than the reference speed, and a low speed lower than the reference speed.

According to this configuration, the corrected transport speed can be controlled to a high speed that is higher than the reference speed based on the reference arrival time and a low speed that is lower than the reference speed based on the reference arrival time. In this manner, by providing the diversity of the corrected transport speed, the transport speed of the medium can be corrected in both a case where the medium arrives at the predetermined position early and a case where the medium arrives at the predetermined position late. Therefore, it is possible to improve the performance in transporting the medium.
[3] The medium transport device described above, the control section causes the second transport section to transport the medium at the corrected transport speed in a corrected transport period based on the corrected transport time and the second transport section may be caused to transport the medium at a normal transport speed in a normal transport period other than the corrected transport period.

According to this configuration, the transport speed can be made different between the corrected transport period and the normal transport period. In this manner, by providing the diversity of the transport speed, the transport speed of the medium can be corrected. Therefore, it is possible to improve the performance in transporting the medium.
[4] The medium transport device described above, the transport section further includes a third transport section that transports a medium downstream of the second transport section, the normal transport speed is equal to a transport speed at which the medium is transported by the third transport section, and the control section when the second transport section is caused to transport plural sheets of a medium including a preceding sheet of medium and a subsequent sheet of medium, causes the second transport section to transport the preceding sheet of medium and the subsequent sheet of medium at the normal transport speed in a period in which the trailing end of the preceding sheet of medium is transported by the second transport section and after the second transport section has completed transport of the preceding sheet of medium, the second transport section is caused to transport the subsequent sheet of medium at the corrected transport speed.

According to this configuration, in the period in which the trailing end of the preceding sheet of medium is transported by the second transport section, the preceding sheet of medium and the subsequent sheet of medium can be transported by the second transport section at the same normal transport speed as that of the third transport section. Accordingly, the preceding sheet of medium can be smoothly transported between the second transport section and the third transport section. In addition, after the transport of the preceding sheet of medium by the second transport section is completed, the subsequent sheet of medium can be transported by the second transport section at the corrected transport speed. Accordingly, the subsequent sheet of medium can be transported at the corrected transport speed by the second transport section. Therefore, it is possible to improve the performance in transporting the medium.
[5] The medium transport device described above, the normal transport speed may be slower than the corrected transport speed.

According to this configuration, after the transport of the preceding sheet of medium by the second transport section is completed, the subsequent sheet of medium can be transported by the second transport section at the corrected transport speed higher than the normal transport speed. Accordingly, the transport speed of the subsequent sheet of medium can be increased by the second transport section. Therefore, it is possible to improve the performance in transporting the medium.
[6] The medium transport device described above, the first transport section is a feeding section that feeds a medium accommodated in a medium accommodation section and the normal transport speed may be equal to or higher than a transport speed of the feeding section.

According to this configuration, it is possible to feed the medium at an appropriate transport speed, and even in a case where the transport speed by the feeding section is decreased, it is possible to increase the transport speed by the second transport section. Accordingly, the transport speed of the medium can be increased by the second transport section. Therefore, it is possible to improve the performance in transporting the medium.
[7] The medium transport device described above, the transport section is provided downstream of the second transport section and further includes a registration roller pair against which the medium transported by the second transport section is butted, the normal transport speed is slower than a butting transport speed at which the second transport section butts the medium against the registration roller pair and the low speed and the control section may change the transport speed of the second transport section in the order of the normal transport speed, the corrected transport speed, and the butting transport speed.

According to this configuration, the medium can be caused to butt against the registration roller pair at an appropriate transport speed. In addition, by changing the transport speed of the second transport section in the order of the normal transport speed, the corrected transport speed, and the butting transport speed, it is possible to transport the medium at a transport speed according to the situation. Therefore, it is possible to improve the performance in transporting the medium.
[8] The medium transport device described above, the first transport section is a feeding section that feeds a medium accommodated in a medium accommodation section and the reference speed may be higher than a transport speed of the feeding section.

According to this configuration, even when the transport speed of the feeding section is decreased, the transport speed can be increased by the second transport section. Accordingly, the transport speed of the medium can be increased by the second transport section. Therefore, it is possible to improve the performance in transporting the medium.
[9] The medium transport device described above, the transport section is provided downstream of the second transport section and further includes a registration roller pair against which the medium transported by the second transport section is butted and the low speed may be equal to a butting transport speed at which the second transport section butts the medium against the registration roller pair.

According to this configuration, the medium can be caused to butt against the registration roller pair at an appropriate transport speed. In addition, the number of times of changing the transport speed can be reduced by setting the corrected transport speed by the second transport section to a low speed equal to the butting transport speed. Therefore, it is possible to improve the performance in transporting the medium.
[10] The medium transport device described above, the control section may control the second transport section to perform curvilinear acceleration and deceleration.

According to this configuration, the medium can be transported so as to be accelerated and decelerated in a curvilinear manner. Therefore, it is possible to improve the performance in transporting the medium.
[11] The medium transport device described above, the transport section is provided downstream of the second transport section and further includes a registration roller pair against which the medium transported by the second transport section is butted and the first transport section may be a feeding section that feeds a medium accommodated in a medium accommodation section.

According to this configuration, the medium can be fed at an appropriate transport speed, and the medium can be caused to butt against the registration roller pair at an appropriate transport speed. Therefore, it is possible to improve the performance in transporting the medium.
[12] In the medium transport device described above, the first transport section includes a switching section that can switch between a driving state in which the first transport section rotates at a speed controlled by the control section and a driven state in which the first transport section can be driven to rotate by a medium and the control section is configured to, after the medium reaches the predetermined position, when the corrected transport speed is equal to or higher than the predetermined transport speed, cause the first transport section to rotate at a predetermined transport speed and when the corrected transport speed is lower than the predetermined transport speed, cause the first transport section to rotate at the corrected transport speed.

According to this configuration, when the corrected transport speed of the second transport section is lower than the transport speed of the first transport section, the control section can control the transport speed of the first transport section to the corrected transport speed of the second transport section. Accordingly, the first transport section can transport the medium at an appropriate speed with respect to the second transport section. Therefore, it is possible to improve the performance in transporting the medium.
[13] In the medium transport device described above, the first transport section includes a switching section that can switch between a driving state in which the first transport section rotates at a speed controlled by the control section and a driven state in which the first transport section can be driven to rotate by a medium and the control section is configured to, after the medium reaches the predetermined position, rotating the first transport section at a predetermined transport speed when the corrected transport speed is equal to or higher than the normal transport speed and rotating the first transport section at the corrected transport speed when the corrected transport speed is lower than the normal transport speed. According to this configuration, the same effect as that of [12] can be achieved.
[14] In the medium transport device described above, the control section configured to change the transport speed of the second transport section after changing the transport speed of the first transport section. According to this configuration, the control section can change the transport speed of the second transport section according to the transport speed of the first transport section. Therefore, it is possible to improve the performance in transporting the medium.
[15] A recording device includes a transport section configured to transport a medium and a recording section that performs recording on the medium transported by the transport section; and a control section that controls the transport section and the recording section, wherein the transport section includes a first transport section configured to transport a medium, and a second transport section configured to transport a medium downstream of the first transport section and the control section selects a transport speed of the medium by the second transport section from a plurality of types of predetermined corrected transport speeds based on a difference between an arrival time of the medium at a predetermined position downstream of the first transport section and a reference arrival time, and calculates a corrected transport time for transporting the medium at the corrected transport speed based on the difference and the selected corrected transport speed.

According to this configuration, the same effect as that of [1] can be achieved. In addition, by improving the performance in transporting the medium, it is possible to perform recording on the medium at an appropriate timing.
[16] The recording device described above, the transport section further includes a third transport section that transports a medium downstream of the second transport section and the recording section may perform recording on the medium transported by the third transport section.

According to this configuration, the same effect as that of [12] can be achieved.
[17] A recording system includes a transport section configured to transport a medium and a recording section configured to record on the medium transported by the transport section; a post-processing section configured to perform post-processing on the medium that was recording on by the recording section; and a control section configured to control the transport section, the recording section, and the post-processing section, wherein the transport section includes a first transport section configured to transport a medium, and a second transport section configured to transport a medium downstream of the first transport section and the control section selects a transport speed of the medium by the second transport section from a plurality of types of predetermined corrected transport speeds based on a difference between an arrival time of the medium at a predetermined position downstream of the first transport section and a reference arrival time, and calculates a corrected transport time for transporting the medium at the corrected transport speed based on the difference and the selected corrected transport speed.

According to this configuration, the same effect as that of [1] can be achieved. In addition, by improving the performance in transporting the medium, it is possible to perform post-processing on the medium at an appropriate timing.
[18] A control method for a medium transport device including a first transport section that transports a medium and a second transport section that transports a medium downstream of the first transport section, the control method includes selecting a transport speed of the medium by the second transport section from a plurality of types of predetermined corrected transport speeds based on a difference between an arrival time of the medium at a predetermined position downstream of the first transport section and a reference arrival time and calculating a corrected transport time for transporting the medium at the corrected transport speed based on the difference and the selected corrected transport speed.

According to this configuration, the same effect as that of [1] can be achieved.

What is claimed is:

1. A medium transport device comprising:
a transport section configured to transport a medium and
a control section configured to control the transport section, wherein
the transport section includes a first transport section configured to transport a medium and a second transport section configured to transport a medium downstream of the first transport section and
the control section
selects a transport speed of the medium by the second transport section from a plurality of types of predetermined corrected transport speeds based on a difference between an arrival time of the medium at a predetermined position downstream of the first transport section and a reference arrival time and
calculates a corrected transport time for transporting the medium at the corrected transport speed based on the difference and the selected corrected transport speed.

2. The medium transport device according to claim 1, wherein
the corrected transport speed includes a reference speed based on the reference arrival time, a high speed higher than the reference speed, and a low speed lower than the reference speed.

3. The medium transport device according to claim 2, wherein
the control section
causes the second transport section to transport the medium at the corrected transport speed in a corrected transport period based on the corrected transport time and
causes the second transport section to transport the medium at a normal transport speed in a normal transport period that is not the corrected transport period.

4. The medium transport device according to claim 3, wherein
the transport section further includes a third transport section that transports a medium downstream of the second transport section,
the normal transport speed is equal to a transport speed at which the medium is transported by the third transport section, and
the control section
when the second transport section is caused to transport plural sheets of a medium including a preceding sheet of medium and a subsequent sheet of medium,
causes the second transport section to transport the preceding sheet of medium and the subsequent sheet of medium at the normal transport speed in a period in which the trailing end of the preceding sheet of medium is transported by the second transport section and
after the second transport section has completed transport of the preceding sheet of medium, causes the second transport section to transport the subsequent sheet of medium at the corrected transport speed.

5. The medium transport device according to claim 4, wherein
the normal transport speed is slower than the corrected transport speed.

6. The medium transport device according to claim 3, wherein
the first transport section is a feeding section that feeds a medium accommodated in a medium accommodation section and
the normal transport speed is equal to or higher than a transport speed of the feeding section.

7. The medium transport device according to claim 3, wherein
the transport section is provided downstream of the second transport section and further includes a registration roller pair against which the medium transported by the second transport section is butted,
the normal transport speed is slower than a butting transport speed at which the second transport section butts the medium against the registration roller pair and the low speed, and
the control section changes the transport speed of the second transport section in the order of the normal transport speed, the corrected transport speed, and the butting transport speed.

8. The medium transport device according to claim 2, wherein
the first transport section is a feeding section that feeds a medium accommodated in a medium accommodation section and
the reference speed is higher than a transport speed of the feeding section.

9. The medium transport device according to claim 2, wherein
the transport section is provided downstream of the second transport section and further includes a registration roller pair against which the medium transported by the second transport section is butted and
the low speed is equal to a butting transport speed at which the second transport section butts the medium against the registration roller pair.

10. The medium transport device according to claim 1, wherein
the control section that controls the second transport section so as to perform curvilinear acceleration and deceleration.

11. The medium transport device according to claim 1, wherein
the transport section is provided downstream of the second transport section and further includes a registration roller pair against which the medium transported by the second transport section is butted and
the first transport section is a feeding section that feeds a medium accommodated in a medium accommodation section.

12. The medium transport device according to claim 1, wherein
the first transport section further includes a switching section that can switch between a driving state in which the first transport section rotates at a speed controlled by the control section and a driven state in which the first transport section can be driven to rotate by a medium and
the control section is configured to, after the medium reaches the predetermined position,
when the corrected transport speed is equal to or higher than the predetermined transport speed, cause the first transport section to rotate at a predetermined transport speed and
when the corrected transport speed is lower than the predetermined transport speed, cause the first transport section to rotate at the corrected transport speed.

13. The medium transport device according to claim 3, wherein
the first transport section further includes a switching section that can switch between a driving state in which the first transport section rotates at a speed controlled by the control section and a driven state in which the first transport section can be driven to rotate by a medium and
the control section is configured to, after the medium reaches the predetermined position,
when the corrected transport speed is equal to or higher than the normal transport speed, the first transport section is rotated at a predetermined transport speed and
when the corrected transport speed is lower than the normal transport speed, the first transport section is rotated at the corrected transport speed.

14. The medium transport device according to claim 12, wherein
the control section is configured to change the transport speed of the second transport section after changing the transport speed of the first transport section.

15. A recording device comprising:
a transport section configured to transport a medium;
a recording section that performs recording on the medium transported by the transport section; and
a control section that controls the transport section and the recording section, wherein
the transport section includes a first transport section configured to transport a medium and a second transport section configured to transport a medium downstream of the first transport section and
the control section
selects a transport speed of the medium by the second transport section from a plurality of types of predetermined corrected transport speeds based on a difference between an arrival time of the medium at a predetermined position downstream of the first transport section and a reference arrival time and
calculates a corrected transport time for transporting the medium at the corrected transport speed based on the difference and the selected corrected transport speed.

16. The recording device according to claim 15, wherein
the transport section further includes a third transport section that transports a medium downstream of the second transport section and
the recording section performs recording on the medium transported by the third transport section.

17. A recording system comprising:
a transport section configured to transport a medium;
a recording section configured to record on the medium transported by the transport section;
a post-processing section configured to perform post-processing on the medium that was recording on by the recording section; and
a control section configured to control the transport section, the recording section, and the post-processing section, wherein
the transport section includes a first transport section configured to transport a medium and a second transport section configured to transport a medium downstream of the first transport section and
the control section
selects a transport speed of the medium by the second transport section from a plurality of types of predetermined corrected transport speeds based on a difference between an arrival time of the medium at a predetermined position downstream of the first transport section and a reference arrival time and
calculates a corrected transport time for transporting the medium at the corrected transport speed based on the difference and the selected corrected transport speed.

18. A control method for a medium transport device including a first transport section that transports a medium and a second transport section that transports a medium downstream of the first transport section, the control method comprising:
varying a transport speed of the medium by the second transport section to a first speed based on a difference between an arrival time of the medium at a predetermined position downstream of the first transport section and a reference arrival time and
calculating a corrected transport time for transporting the medium at the first speed based on the difference and the first speed.
